(19) United States
(12) Patent Application Publication
(10) Pub. No.: US 2015/0199058 A1
(43) Pub. Date: Jul. 16, 2015

(54) INFORMATION PROCESSING METHOD AND ELECTRONIC DEVICE

(71) Applicants: Lenovo (Beijing) Limited, Beijing (CN); Beijing Lenovo Software Ltd., Beijing (CN)

(72) Inventor: Shihang Zhang, Beijing (CN)

(21) Appl. No.: 14/460,866

(22) Filed: Aug. 15, 2014

(30) Foreign Application Priority Data
Jan. 13, 2014 (CN) 201410014452.5

(51) Int. Cl. G06F 3/041; G06F 21/82

(52) U.S. Cl. CPC G06F 3/0412; G06F 21/82

(57) ABSTRACT

The present invention relates to information processing methods and electronic devices for addressing that the user cannot be provided with sufficient prompt information by the unlocking interface. The method may comprise: acquiring a first operation in the first status; determining whether the first operation complies with a first preset condition to obtain a first determination result, the first preset condition including a first sub-condition and a second sub-condition; when the first determination result indicates that the first operation satisfies the first sub-condition, analyzing the first operation to obtain the first target application of the first operation and controlling the display unit to display the first image of the first target application in the first status; when the first determination result indicates that the first operation satisfies both the first sub-condition and the second sub-condition, analyzing the first operation to obtain the first target application of the first operation, controlling the electronic device to switch from the first status to the second status, and controlling the display unit to display the first image of the first target application.

### CROSS-REFERENCE TO RELATED APPLICATION

This application claims the benefit of priority under 35 U.S.C. 119 to the Chinese Application No. 201410014452.5, filed on Jan. 13, 2014, which application is incorporated herein by reference in its entirety.

### TECHNICAL FIELD

The present invention relates to electronic technology, and particularly to information processing methods and electronic devices.

### BACKGROUND

With development of science and technology, electronic devices are rapidly developing. There are more types of electronic products, and people enjoy conveniences brought by the evolution of science and technology. Nowadays, by using various types of electronic devices, people can enjoy comfortable lives brought by the science and technology development. Devices with touch screens have become more widespread. Due to their flexibility, unexpected touching may easily occur. Therefore, the technique of screen-locking emerges, and accompanying with it is the screen-unlocking technique. Conventionally, there are a plurality of unlocking manners, such as Sudoku, password, sliding bar, etc.

After unlocking, users can use other functionalities of the electronic devices.

However, when inventor is implementing the conventional solutions, following technical problems have been raised.

Conventionally, an application keeps active before a last screen-locking, and the display will return to an interface of the application after the screen is unlocked. Generally, the user may forget the application previously activated when unlocking the screen, and will be unknown of which application interface will be shown after unlocking. Therefore, there is a problem that the user cannot be provided with sufficient prompt information by the unlocking interface.

The problem in the prior art that user cannot be provided with sufficient prompt information by the unlocking interface brings user poor experience.

### SUMMARY

Embodiments of the present invention provide information processing methods and electronic devices for addressing the problem in the conventional art that the user cannot be provided with sufficient prompt information by the unlocking interface. An effect of providing the user with sufficient prompt information by the unlocking interface is achieved.

Firstly, embodiments of the present application provide an information processing method in an electronic device including at least a display unit; the electronic device can operate at least in a first status and a second status which is different from the first status; the electronic device includes an instruction set comprising first instruction subsets and second instruction subsets; the electronic device may execute the first instruction subsets when the electronic device is in the first status, and the electronic device can execute the second instruction subsets when it is in the second status; wherein, the number of the first instruction subsets is less than that of the second instruction subset. The method comprises: acquiring a first operation in the first status; determining whether the first operation complies with a first preset condition or not to obtain a first determination result, the first preset condition including a first sub-condition and a second sub-condition; when the first determination result indicates that the first operation satisfies the first sub-condition, analyzing the first operation to obtain the first target application of the first operation and controlling the display unit to display a first image for the first target application in the first status; if the first determination result indicates that the first operation satisfies both the first sub-condition and the second sub-condition, analyzing the first operation to obtain the first target application of the first operation, controlling the electronic device to switch from the first status to the second status, and controlling the display unit to display the first image of the first target application.

Additionally, the controlling the display unit in the first status to display the first image of the first target application comprises: controlling the display unit in the first status to display the first image in an entire display region of the display unit; or controlling the display unit in the first status to display the first image in part of the display region of the display unit.

Additionally, the controlling the display unit in the first status to display the first image of the first target application comprises: controlling the display unit in the first status to gradually improve a definition of the first image of the first target application displayed in the entire display region of the display unit during the first operation; or controlling the display unit in the first status to gradually improve the definition of the first image of the first target application displayed in part of the display region of the display unit during the first operation.

Additionally, before the first determination result indicates that the first operation satisfies both the first sub-condition and the second sub-condition, analyzing the first operation to obtain the first target application of the first operation, and controlling the electronic device to switch from the first status to the second status, the method further comprises, for a buffering interval before the electronic device enters the second status, displaying the first image of the target application as a buffering interval interface.

Additionally, after determining whether the first operation complies with a first preset condition to obtain a first determination result, the method further comprises: determining whether the first operation satisfies a third sub-condition to obtain a second determination result, when the first determination result indicates that the first operation satisfies the first sub-condition but not the second sub-condition; adjusting the display effect of the first image when the second determination result indicates that the first operation satisfies the third sub-condition; obtaining a second target application corresponding to the first operation based on the first operation which satisfies the third sub-condition; and controlling the display unit to display a second image of the target application.

Additionally, the adjusting the display effect of the first image comprises: adjusting the display effect of the first image so as to decrease a definition of the first display effect gradually.

Additionally, the first image comprises a current interface image of the first target application before the electronic device is in the first status; or an image associated with the first target application.

Additionally, the first image comprises a real-time image of the first target application.

Firstly, embodiments of the present application also provide an electronic device including at least a display unit, and the electronic device can operate at least in a first status and a second status which is different from the first status, the electronic device includes an instruction set comprising a first instruction subset and a second instruction subset; the electronic device can execute the first instruction set when it is in the first status, and the electronic device can execute the second instruction subset when it is in the second status, wherein, the number of the first instruction subset is less than that of the second instruction subset, the electronic device comprises: a first acquiring unit, configured to acquire a first operation in the first status; a determining unit, configured to determine whether the first operation complies with a first preset condition to obtain a first determination result, the first preset condition including a first sub-condition and a second sub-condition; a first control unit, configured to, when the first determination result indicates that the first operation satisfies the first sub-condition, analyze the first operation to obtain a first target application of the first operation and control the display unit to display a first image of the first target application in the first status; a first control unit, configured to, when the first determination result indicates that the first operation satisfies the first sub-condition and the second sub-condition, analyze the first operation to obtain the first target application of the first operation, control the electronic device to switch from the first status to the second status and control the display unit to display the first image of the first target application.

One or more solutions provided in the embodiments of the present application at least have following technical effects and advantages:

According to the embodiments of the present invention, the electronic device is configured to acquire the first operation in the first status, determine whether the first operation complies with a first preset condition comprising a first sub-condition and a second sub-condition; when the first operation satisfies the first sub-condition, to obtain the first target application of the first operation and control the display unit in the first status to display the first image of the first target application; when the first operation satisfies both the first sub-condition and the second sub-condition, to control the electronic device to switch from the first status to the second status, and control the display unit to display the first image of the first target application. Thus, following problem may be addressed: if an application in an electronic device keeps active before the last screen-locking, the display will return to the interface of the application after the screen is unlocked; however, generally, the user may forget the application previously activated when unlocking the screen, and will be unknown of to which application interface the electronic device will return after unlocking; therefore, there is a problem that user may not be provided with sufficient prompt information by the unlocking interface.

### BRIEF DESCRIPTION OF THE DRAWINGS

FIG. 1 is a flow diagram of an information processing method according to an embodiment of the present application;

FIG. 2 is a schematic diagram of an unlocking interface according to an embodiment of the present application;

FIG. 3 is a schematic diagram of displaying a preview when the first application is the application for acquiring pre-download information from a server according to the embodiments of the present application;

FIG. 4 is a schematic diagram of displaying a preview when the first application is a communication application according to the embodiments of the present application;

FIG. 5 is a schematic diagram of displaying a preview when the first application is a web page application according to the embodiments of the present application;

FIG. 6 is a block diagram of an electronic device according to the embodiments of the present application.

### DETAILED DESCRIPTION OF THE EMBODIMENTS

Embodiments of the present application provide information processing methods and electronic devices for solving the problem that user cannot be provided with the sufficient prompt information by the unlocking interface.

The main idea of the solution in embodiments of the present application for solving the problem may be described as follows.

The electronic device can operate in two statuses, specifically, a first status and a second status which is different from the first status. The electronic device includes an instruction set comprising the first instruction subsets and the second instruction subsets; the electronic device can execute the first instruction sets when it is in the first status; and the electronic device can execute the second instruction subsets when it is in the second status. Specifically, the electronic device is configured to acquire a first operation in the first status; then determine whether the first operation complies with a first preset condition or not to obtain a first determination result, the first preset condition including a first sub-condition and a second sub-condition. When the first determination result indicates that the first operation satisfies the first sub-condition, the electronic device is configured to analyze the first operation to obtain the first target application of the first operation and control the display unit to display the first image of the first target application in the first status; when the first determination result indicates that the first operation satisfies both the first sub-condition and the second sub-condition, to analyze the first operation to obtain the first target application of the first operation, control the electronic device to switch from the first status to the second status and control the display unit to display the first image of the first target application. Thus, the effect of providing the user with sufficient prompt information by the unlocking interface is achieved.

To better understand the solution described above, the embodiments of the present application will be explained in detail with reference to the drawings.

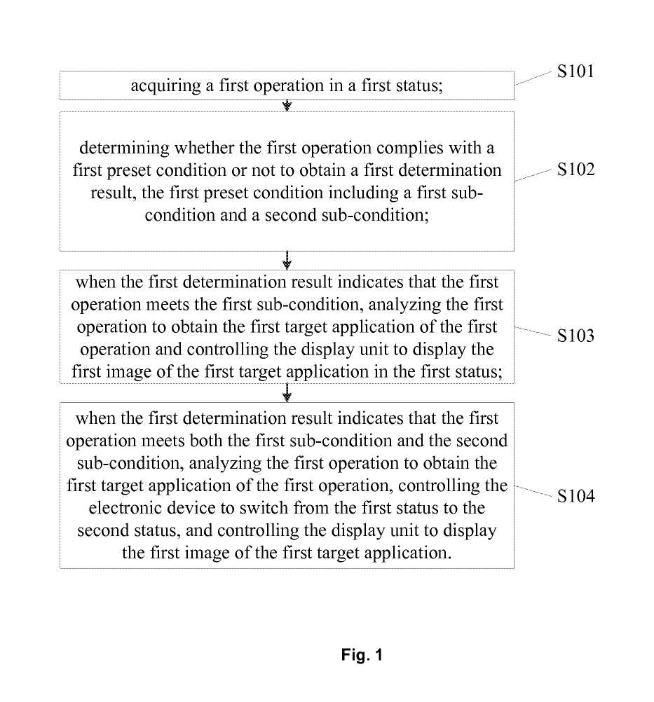

The embodiments provide an information processing method in an electronic device capable of screen-locking such as a tablet computer, a smart mobile phone, a laptop, etc. The electronic device can operate in a first status and a second status which is different from the first status. The electronic device includes an instruction set comprising the first instruction subsets and the second instruction subsets. The electronic device can execute the first instruction subsets when it is in the first status; and execute the second instruction subsets when it is in the second status; wherein, the number of the first instruction subsets is less than that of the second instruction subsets, as depicted in FIG. 1, the information processing method may comprise steps of:

S101, acquiring a first operation in the first status;

S102, determining whether the first operation complies with a first preset condition or not to obtain a first determination result, the first preset condition including a first sub-condition and a second sub-condition;

S103, when the first determination result indicates that the first operation satisfies the first sub-condition, analyzing the first operation to obtain the first target application of the first operation and controlling the display unit to display the first image of the first target application in the first status;

S104, when the first determination result indicates that the first operation satisfies the first sub-condition and the second sub-condition, analyzing the first operation to obtain the first target application of the first operation, controlling the electronic device to switch from the first status to the second status, and controlling the display unit to display the first image of the first target application.

In S101, the electronic device is operated in the first status and acquires the first operation. The first status may be a status in which the electronic device is screen-locked and the screen is illumined. Specifically, the acquired first operation may be a sliding operation or a gesture by the user.

After acquiring the first operation, S102 is executed for determining whether the first operation complies with a first preset condition or not to obtain a first determination result. The first preset condition includes a first sub-condition and a second sub-condition.

### Embodiment 1

After obtaining the first operation of the first user, the electronic device is configured to determine whether the first operation satisfies the first sub-condition. The first sub-condition may be a condition in which a sliding operation or a gesture by the first user moving towards any of unlocking icons on an unlocking interface but having not reached the corresponding unlocking icon. After determining the first operation satisfies the above illustrated condition, a preview of the first image for the last opened interface of the first target application corresponding to the unlocking icon to which the sliding operation or gesture is moving, is displayed.

For example, when it is determined that the user was sliding towards an unlocking icon corresponding to SMS, a SMS which the user last activated is displayed on the unlocking interface, when it is determined that the user was sliding towards an unlocking icon corresponding to email, an email which the user last activated is displayed on the unlocking interface, and when it is determined that the user was sliding towards the unlocking-only icon, a first image of the active application before locking is displayed on the unlocking interface.

A display of the first image of an interface of a SMS, email or another application on the displaying interface may be a display of the first image on part of the unlocking interface, or may also be a display of the first image on the entire unlocking interface. The display effect may be in a fade-in manner.

After the first operation satisfies the first sub-condition, the electronic device is configured to determine whether the first operation satisfies the second sub-condition. The second sub-condition may be a condition in which after the sliding operation or the gesture by the user in the first operation reaches the corresponding unlocking icon.

For example, when it is determined that the first operation moves towards the unlocking icon corresponding to SMS and it reaches the corresponding unlocking icon, the first operation is analyzed so that the electronic device is switched from the first status to the second status, i.e. switched from the locking status to the unlocking status. When switching to the unlocking status, in the above example, if the first operation is a sliding operation towards a SMS unlocking icon, the SMS interface will be displayed after unlocking. If the first operation is a sliding operation towards the email unlocking icon, the email interface will be displayed after unlocking. If the first operation is a sliding operation towards the unlocking-only icon, the interface of the activated application before the last locking will be displayed after unlocking. The case of a sliding operation towards the unlocking icon will be omitted herein for concise.

### Embodiment 2

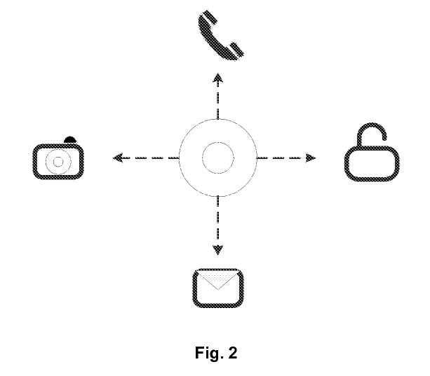

When obtaining the first operation of the first user, the electronic device may determine whether the first operation satisfies the first sub-condition or not. The first sub-condition may be a condition in which the first user touches a center circle of the unlocking interface as depicted in FIG. 2. When it is determined that the first sub-condition is met, a first image of the preview of the application which was activated before unlocking is displayed on the unlocking interface. In particular, the method comprises:

Firstly, when the first determination result indicates that the first operation satisfies the first sub-condition, the electronic device analyzes the first operation to obtain the first target application of the first operation, and controls the display unit to display the first image of the first target application in the first status.

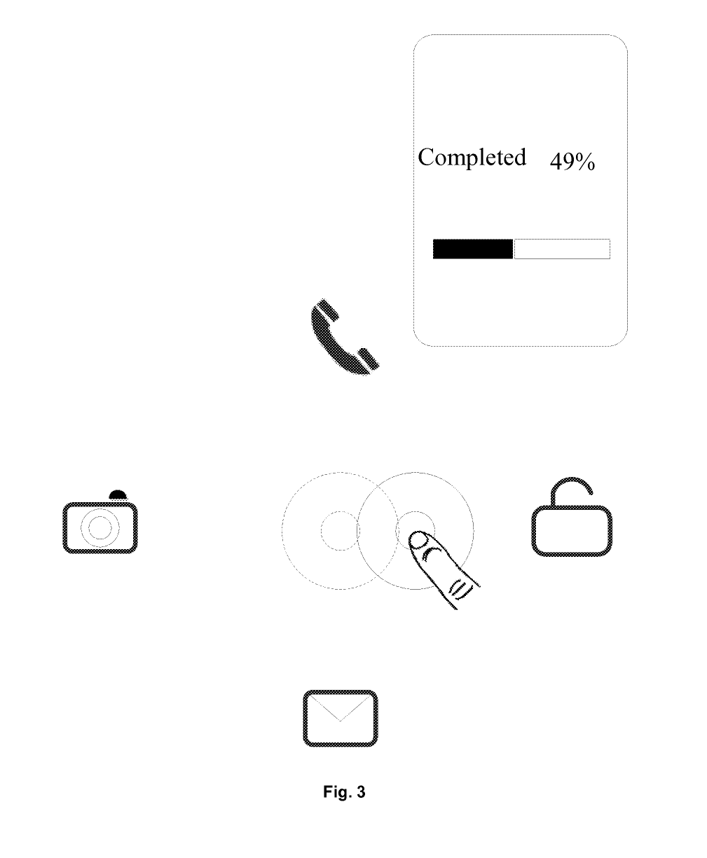

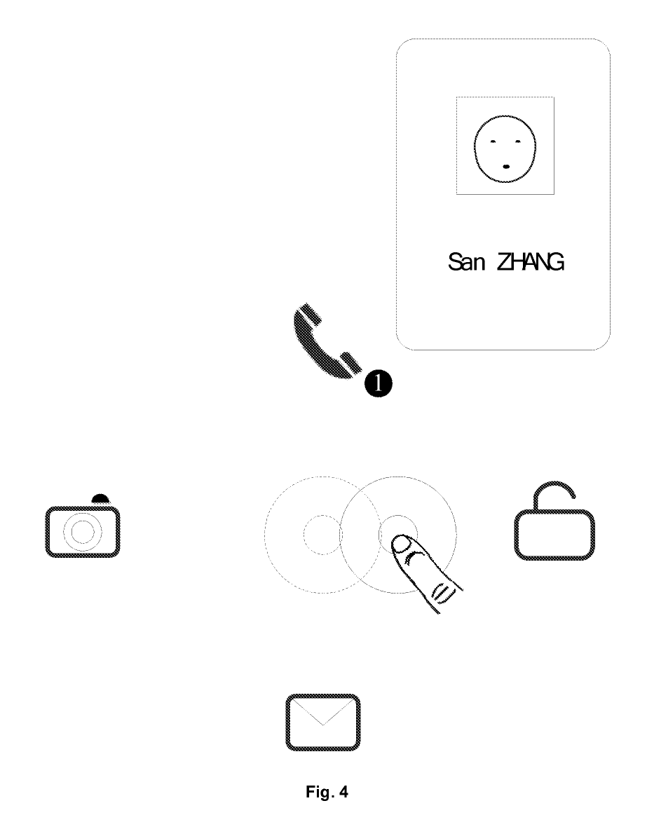

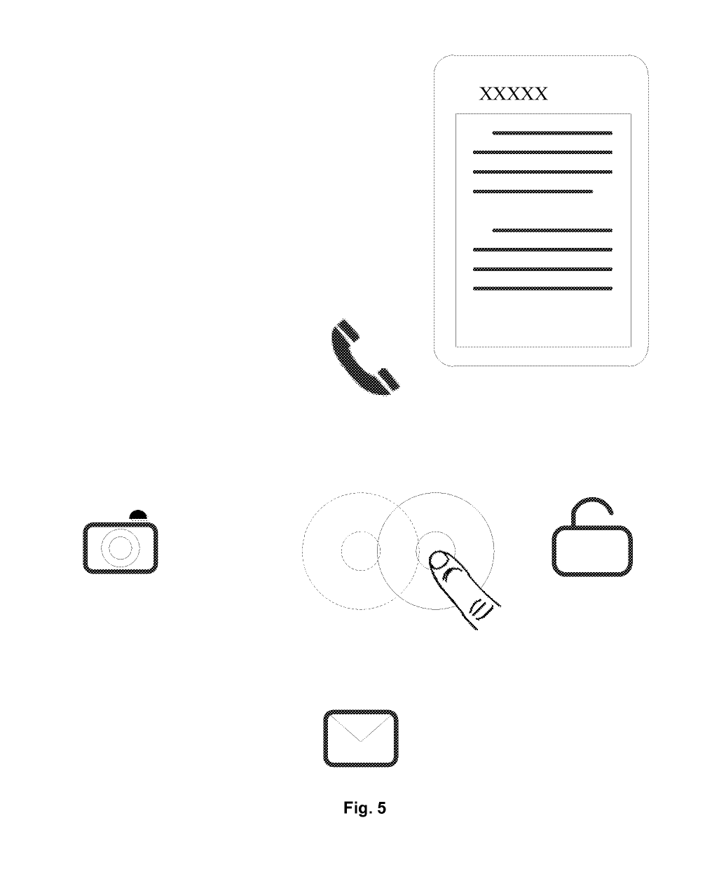

As depicted in FIG. 2, when detecting, on the unlocking interface shown in the figure, that user taps the center circle followed by a sliding operation, it is determined that the first operation satisfies the first sub-condition. By analyzing the above illustrated operation, an application (i.e., a first target application) corresponding to the sliding operation by the user is obtained, and a first image of the first target application is displayed on the unlocking interface, as shown in FIG. 3, FIG. 4 and FIG. 5.

As depicted in FIG. 3, when the first target application is an application acquiring pre-download information from a server, the preview represents a percentage of the pre-download information downloaded by the first application.

As depicted in FIG. 4, when the first target application is a communication application, the preview represents identification information of the user on a counterpart of the communication.

As depicted in FIG. 5, when the first target application is a web browser application, the preview represents a web page which the user was browsing.

In S103, controlling the display unit to display the first image of the first target application in the first status may comprise:
controlling the display unit in the first status to display the first image in the entire display region of the display unit; or
controlling the display unit in the first status to display the first image in part of the display region of the display unit.

Specifically, the electronic device controls the display unit in the first status to gradually improve the definition of the first image of the first target application displayed in the entire display region of the display unit during the first operation; or
the electronic device controls the display unit in the first status to gradually improve the definition of the first image of the first target application displayed in part of the display region of the display unit during the first operation.

The above illustrated scenarios in connection with FIG. 3, FIG. 4 and FIG. 5 are approaches of displaying the first image in part of the display region of the display unit.

The above illustrated scenarios will be detailed as follows.

For the first scenario, in a specific implementation, the user may start a task of downloading a video clip before locking the screen of the smart phone. Then, the user put the smart phone aside. The smart phone enters a screen-locking status (i.e. a first status) if it has not been touch for a long time, but the video-downloading task is still running in the background. When the user is unlocking the screen by a sliding operation, a first image of preview of the downloading progress of the TV series will be displayed in part of region on an upper-right corner of the display unit in the unlocking interface. The first image may be displayed in a way that definition gradually increases, that is, the first image becomes clearer, as shown in FIG. 3. On the other hand, the preview of the downloading progress of TV series may be displayed in the entire region of the display unit. In embodiments of the present application, the task could be the download of other applications. In embodiments of the present application, the first application in the first scenario may also be an application for updating software. When the screen is locked, the task of updating software is still running in the background. The embodiments of the present application may not be limited to these.

In a first scenario, as shown in FIG. 3, the first image of the preview will present not only when a slider slides to a right icon, but also to respective up, down or left icons. When the user wants to quickly return to an application interface, an appropriate direction of the sliding operation may be selected to activate the corresponding icon.

Then, a second scenario will be described. In specific implementation, an incoming call from a counterpart arrives at the smart phone. A user of the smart phone failed to pick up the phone call in time. When the user returns and checks the smart phone, prompt information of the missed call will be displayed on the unlocking interface. Conventionally, the prompt information may only indicate the number of missed calls, and may not indicate information about the counterpart. In the present application, when the user slides the slider to unlock the screen, a first image including the information of the counterpart will be displayed on part of the region in the unlocking interface. A portrait information and/or name information, etc. of the counterpart will be displayed on the first image. The first image may be displayed in a way that its definition gradually increases. On the other hand, as shown in FIG. 4, in embodiments of the present application, the first target application could also be a SMS application, a chat tool with real-time message, etc. The embodiments of the present application may not be limited to these.

Next, a third scenario will be described. In a specific implementation, before the screen of the smart phone is locked, the user was browsing web pages with a web browser. During the unlocking operation, as shown in FIG. 5, when the user slides the slider to any of the unlocking icons, a first image of the web page viewed before screen-locking will be displayed on part of the region in the unlocking interface. The first image may be displayed in a way that its definition gradually increases, that is, the first image becomes clearer. From the first image, the user can clearly view the browsed web page, and obtain a well experience.

In the third scenario, before the screen-locking, both a web page viewed with a web browser and an interface of an application accessed may be displayed. Before the screen-locking, the current interface will be maintained, and the user is able to return to the previously opened interface after a future screen-unlocking. In the present application, the current interface is not limited to these.

In the above described three scenarios, the first image is displayed on part of region of the display unit. Discussion will be omitted when the first image is displayed on the entire region of the display unit.

From the obtained first image in the above described three scenarios, the user can easily know the active applications before screen-locking. The first image is the real-time image of the first target application which shows the status when the application was last activated, or the status of its current progress. Then, the electronic device will determine which unlocking icon the slider is sliding forward to, i.e., determine whether the first operation, while satisfies the first sub-condition, also satisfies the second sub-condition. The second sub-condition may be a condition in which the first operation points to an icon corresponding to the preview displayed previously. For example, when the first operation points to a SMS unlocking icon, it does not correspond to the preview of a web page browser, and the first operation does not satisfy the second sub-condition; when the first operation points to an unlocking-only icon, it corresponds to the preview of a web page browser.

When the first operation points to an icon corresponding to the first target application, it is indicated that the first operation also satisfies the second sub-condition. Then the electronic device analyzes the first operation to obtain the first target application of the first operation, and switches from the first status to the second status.

Before the electronic device switches from the first status to the second status, the method further comprises:
during a buffering interval before the electronic device enters the second status, displaying the first image of the target application.

In a specific implementation, when entering the second status, a short buffering interval exists when the electronic device is reading information stored in a memory before screen-locking. Thus, during this buffering interval, an enlarged view of the first image is displayed. That is, the interface of a browser when the user activated a Weibo will be displayed on the display for a short while after screen-unlocking. As a result, a screenshot will be displayed instead of a black screen and the user will subject to a better experience on the switching between interfaces.

The first operation described above satisfies both the first sub-condition and the second sub-condition. Another scenario will be described hereinafter when the first operation satisfies the first sub-condition and a third sub-condition, but not the second sub-condition. Thus, the method further comprises:
determining whether the first operation satisfies a third sub-condition to obtain the second determination result, when the first determination result indicates that the first operation satisfies the first sub-condition but not the second sub-condition;
adjusting the display effect of the first image, when the second determination result indicates that the first operation satisfies the third sub-condition;
obtaining the second target application corresponding to the first operation, based on the first operation which satisfies the third sub-condition;
controlling the display unit to display the second image of the target application.

In specific application, the third sub-condition may be condition in which the first operation points to another direction other than the first application target. In this case, the direction to which the first operation points is acquired to determine the corresponding second target application. That is, if the first operation satisfies the first sub-condition, the obtained first image is the interface of the web page which is last opened. When the first operation points to a phone call icon, the display effect of the first image of an interface of the above described web page will be changed. That is, the display effect of the first image will be changed so that its definition gradually decreases. Then, the definition of the first image of the missed call preview gradually increases. Thereby, before the first operation reaches the phone-call unlocking icon, the first image of the preview of web page interface will be changed to a first image of the preview of missed-calls or last phone-call record.

Upon the first operation reaches the phone-call unlocking icon, a display after screen-unlocking will be displayed. For example, the information of missed-call or the last phone-call record will be displayed on the interface.

According to the second embodiment, both the interface of the application before the screen-locking, and the interface of history for the recently-activated application to be switched, can be viewed on the unlocking interface. The user will clearly know the current operation status of the electronic device and obtain a better experience.

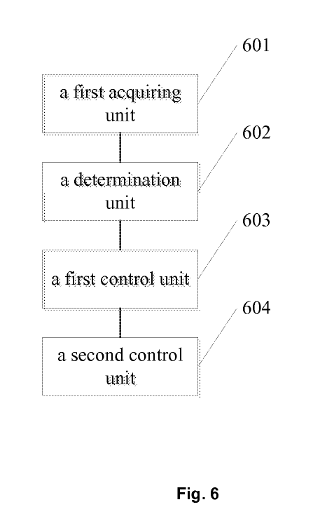

Embodiments of the present application provide an electronic device, as shown in FIG. 6, which may comprise:
a first acquiring unit 601, configured to acquire a first operation in the first status;
a determination unit 602, configured to determine whether the first operation complies with a first preset condition or not to obtain a first determination result, the first preset condition including a first sub-condition and a second sub-condition;
a first control unit 603, configured to, when the first determination result indicates that the first operation satisfies the first sub-condition, analyze the first operation to obtain the first target application of the first operation, and control the display unit in the first status to display the first image of the first target application;
a second control unit 604, configured to, when the first determination result indicates that the first operation satisfies both the first sub-condition and the second sub-condition, analyze the first operation to obtain the first target application of the first operation, control the electronic device to switch from the first status to the second status, and control the display unit to display the first image of the first target application.

In particular, the first control unit 603 is configured to:
control the display unit in the first status to display the first image in the entire display region of the display unit; or
control the display unit in the first status to display the first image in part of the display region.

Additionally, the first control unit 603 is configured to:
control the display unit in the first status to gradually improve the definition of the first image of the first target application displayed in the entire display region of the display unit during the first operation; or
control the display unit in the first status to gradually improve the definition of the first image of the first target application displayed in part of the display region during the first operation.

Additionally, the electronic device further comprises:
a buffering interval display unit, configured to before the electronic device is controlled to be switched from the first status to the second status, display the first image of the first target application as a buffering interval interface for the buffering interval before the electronic device is entering the second status.

Additionally, the electronic device further comprises:
a first determination sub-unit, configured to determine whether the first operation satisfies a third sub-condition or not to obtain the second determination result, when the first determination result indicates that the first operation satisfies the first sub-condition but not the second sub-condition;
an adjusting unit, configured to adjust the display effect of the first image, when the second determination result indicates that the first operation satisfies the third sub-condition;
a second acquiring unit, configured to acquire the second target application corresponding to the first operation, based on the first operation satisfying the third sub-condition;
a third control unit, configured to control the display unit to display the second image of the target application.

Additionally, the adjusting unit is configured to:
adjust the display effect of the first image so that the definition of the first display effect gradually decreases.

According to the embodiments of the present invention, at least following technical effects and advantages may be achieved.

Because the electronic device acquires a first operation in the first status, determines whether the first operation is in accordance with a first preset condition which includes a first sub-condition and a second sub-condition, when the first operation satisfies the first sub-condition, obtains the first target application of the first operation and controls the display unit in the first status to display the first image of the first target application, and when the first operation satisfies both the first sub-condition and the second sub-condition, controls the electronic device to switch from the first status to the second status, and controls the display unit to display the first image of the first target application, the effect of providing the user with sufficient prompt information by the unlocking interface is achieved.

The electronic device illustrated in the embodiment is the electronic device used to implement the information processing method in embodiments of the present application. Therefore, based on the information processing method in embodiments of the present application, those skilled in the art can appreciate the specific implementation of the electronic device in the embodiment and a broad range of variations thereof. Consequently, detailed illustration of the electronic device will be omitted herein. The electronic devices used to implement the information processing method in embodiments of the present application by those skilled in the art all belong to the scope of the present application.

It will be appreciated by those skilled in the art that the embodiments of the present invention can be provided as methods, systems or computer program products. Therefore, the present invention may be in a form of hardware, software, or combination of software and hardware. Furthermore, the present invention may be in a form of a computer program product implemented on one or more computer usable storage medium(s) (including but not limited to magnetic disk memory, CD-ROM, optical memory, etc.) containing computer usable program code.

The present invention is described by referring to flow chart and/or block diagrams of the methods, devices (systems) and computer program products according to the embodiments of the present invention. It should be understood that each flow and/or block of the flow chart diagrams and/or block diagrams, or combined flows and/or blocks of the flow chart diagrams and/or block diagrams can be implemented by computer program instructions. There computer program instructions may be provided to a general computer, a dedicated computer, an embedded processor or a processor of other programmable data processing devices to generate a machine, such that instructions executed by computers or processors of other programmable data processing devices generate appliances implementing functions specified in one or more flow(s) in flow chart diagrams and/or one or more block(s) in block diagrams.

The computer program instructions may be stored in a computer readable memory which can conduct computers or other programmable data processing devices to operate in a specific manner, such that instructions stored in the computer readable memory generate manufactures including instruction appliances, the instruction appliances implement functions specified in one or more flow(s) in flow chart diagrams and/or one or more block(s) in block diagrams.

There computer program instructions can also be loaded onto computers or other programmable data processing devices, such that a series of operation steps can be executed on computers or other programmable devices to generate computer implemented processing. Therefore, instructions executed on the computers or other programmable data processing devices provide steps of functions specified in one or more flow(s) in flow chart diagrams and/or one or more block(s) in block diagrams.

Specifically, the computer program instructions corresponding to the information processing method in the embodiments of present application can be stored in storage medium such as optical disc, hard drive or flash drive etc. When the computer program instructions corresponding to the information processing method in the storage medium are read and executed by an electronic device, the electronic device is allowed to perform any one or more of the following steps:
acquiring a first operation in the first status;
determining whether the first operation complies with a first preset condition or not to obtain a first determination result, the first preset condition including a first sub-condition and a second sub-condition;
when the first determination result indicates that the first operation satisfies the first sub-condition, analyzing the first operation to obtain the first target application of the first operation, and controlling the display unit to display the first image of the first target application in the first status;
when the first determination result indicates that the first operation satisfies both the first sub-condition and the second sub-condition, analyzing the first operation to obtain the first target application of the first operation, controlling the electronic device to switch from the first status to the second status, and controlling the display unit to display the first image of the first target application.

Optionally, when the computer instructions stored in the storage medium and corresponding to the steps of controlling the display unit in the first status to display the first image of the first target application are executed, the electronic device is allowed to perform any one or more of the following steps:
controlling the display unit in the first status to display the first image in the entire display region of the display unit; or
controlling the display unit in the first status to display the first image in part of the display region of the display unit.

Optionally, when the computer instructions stored in the storage medium and corresponding to the steps of controlling the display unit in the first status to display the first image of the first target application are executed, the electronic device is allowed to perform any one or more of the following steps:
controlling the display unit in the first status to gradually improve the definition of the first image of the first target application displayed in the entire display region of the display unit during the first operation; or
controlling the display unit in the first status to gradually improve the definition of the first image of the first target application displayed in part of the display region of the display unit during the first operation.

Optionally, the computer instructions stored in the storage medium are executed so that before analyzing the first operation to obtain the first target application of the first operation, and controlling the electronic device to switch from the first status to the second status, the electronic device is allowed to perform any one or more of the following steps:
for the buffering interval before the electronic device enters the second status, displaying the first image of the target application as a buffering interval interface.

Optionally, the computer instructions stored in the storage medium are executed so that after determining whether the first operation is in accordance with a first preset condition to obtain a first determination result, the electronic device is allowed to perform any one or more of the following steps:
determining whether the first operation satisfies a third sub-condition to obtain the second determination result, when the first determination result indicates that the first operation satisfies the first sub-condition but not the second sub-condition;
adjusting the display effect of the first image, when the second determination result indicates that the first operation satisfies the third sub-condition;
obtaining the second target application corresponding to the first operation, based on the first operation which satisfies the third sub-condition; and
controlling the display unit to display the second image of the target application.

Optionally, when the computer instructions stored in the storage medium and corresponding to the step of adjusting the display effect of the first image are executed, the electronic device is allowed to perform any one or more of the following steps:
adjusting the display effect of the first image so that the definition of the first display effect gradually decreases.

Although preferred embodiments of the present invention have been described, additional alternations and modifications can be made to these embodiments when those skilled in the art know basic inventive concepts. As a result, the appended claims are intended to be explained as including preferred embodiments and all the alternations and modifications falling in the scope of the present invention.

Apparently, various modifications and variations can be made by those skilled in the art without departing the spirit and scope of present invention. Thus, if modification and variations of the present invention fall into the scope of the claims of the present invention and equivalents thereof, the present invention also encompass such modification and variations.

What is claimed is:

1. An information processing method in an electronic device including at least a display unit and operating in at least a first status and a second status which is different from the first status; the electronic device includes an instruction set comprising first instruction subsets and second instruction subsets; the electronic device is configured to execute the first instruction subsets when it is in the first status and execute the second instruction subsets when it is in the second status; wherein, the number of the first instruction subsets is less than that of the second instruction subsets, the method comprising:
acquiring a first operation in the first status;
determining whether the first operation complies with a first preset condition or not so as to obtain a first determination result, the first preset condition including a first sub-condition and a second sub-condition;
when the first determination result indicates that the first operation satisfies the first sub-condition, analyzing the first operation to obtain a first target application of the first operation, and controlling the display unit in the first status to display a first image of the first target application;
when the first determination result indicates that the first operation satisfies both the first sub-condition and the second sub-condition, analyzing the first operation to obtain the first target application of the first operation, controlling the electronic device to switch from the first status to the second status, and controlling the display unit to display the first image of the first target application.

2. The method of claim 1, wherein, the controlling the display unit in the first status to display the first image of the first target application further comprises:
controlling the display unit in the first status to display the first image in an entire display region of the display unit; or
controlling the display unit in the first status to display the first image in part of the display region of the display unit.

3. The method of claim 2, wherein, the controlling the display unit in the first status to display the first image of the first target application further comprises:
controlling the display unit in the first status to gradually improve a definition of the first image of the first target application displayed in the entire display region of the display unit during the first operation; or
controlling the display unit in the first status to gradually improve a definition of the first image of the first target application displayed in part of the display region of the display unit during the first operation.

4. The method of claim 1, wherein, before analyzing the first operation to obtain the first target application of the first operation, controlling the electronic device to switch from the first status to the second status, the method further comprises:
displaying the first image of the target application as a buffering interval interface for the buffering interval before the electronic device enters the second status.

5. The method of claim 4, wherein, after determining whether the first operation complies with a first preset condition to obtain a first determination result, the method further comprises:
determining whether the first operation satisfies a third sub-condition or not so as to obtain a second determination result, when the first determination result indicates that the first operation satisfies the first sub-condition but not the second sub-condition;
adjusting a display effect of the first image, when the second determination result indicates that the first operation satisfies the third sub-condition;
obtaining the second target application corresponding to the first operation, based on the first operation which satisfies the third sub-condition;
controlling the display unit to display a second image of the second target application.

6. The method of claim 5, wherein, the adjusting the display effect of the first image further comprises:
adjusting the display effect of the first image so that the definition of the first display effect gradually decreases.

7. The method of any of claims 1, wherein, the first image comprise a current interface image of the first target application before the electronic device is in the first status; or an image associated with the first target application.

8. The method of any of claims 1, wherein, the first image comprise a real-time image of the first target application.

9. An electronic device including at least a display unit, and configured to be operate in at least a first status and a second status which is different from the first status; the electronic device includes an instruction set comprising first instruction subsets and second instruction subsets; the electronic device is configured to execute the first instruction sets when it is in the first status and execute the second instruction subsets in the instruction set when it is in the second status; wherein, the number of the first instruction subsets is less than that of the second instruction subsets, the electronic device further comprises:
a first acquiring unit configured to acquire a first operation in the first status;
a determination unit configured to determine whether the first operation complies with a first preset condition or not to obtain a first determination result, the first preset condition including a first sub-condition and a second sub-condition;
a first control unit configured to, when the first determination result indicates that the first operation satisfies the first sub-condition, analyze the first operation to obtain the first target application of the first operation, and control the display unit in the first status to display a first image of the first target application;
a second control unit configured to when the first determination result indicates that the first operation satisfies both the first sub-condition and the second sub-condition, analyze the first operation to obtain the first target application of the first operation, control the electronic device to switch from the first status to the second status, and control the display unit to display the first image of the first target application.

10. The electronic device of claim 9, wherein, the first control unit is configured to:
control the display unit in the first status to display the first image in the entire display region of the display unit; or
control the display unit in the first status to display the first image in part of the display region of the display unit.

11. The electronic device of claim 9, wherein, the first control unit is configured to:
control the display unit in the first status to gradually improve the definition of the first image of the first target application displayed in an entire display region of the display unit during the first operation; or
control the display unit in the first status to gradually improve the definition of the first image of the first target application displayed in part of the display region of the display during the first operation.

12. The electronic device of claim 9, wherein, the electronic device further comprises:
a buffering interval display unit configured to, before the electronic device is controlled to be switched from the first status to the second status, display the first image of the first target application as a buffering interval interface for the buffering interval before the electronic device is entering the second status.

13. The electronic device of claim 9, wherein, the electronic device further comprises:
a first determination sub-unit configured to determine whether the first operation satisfies a third sub-condition or not to obtain a second determination result, when the first determination result indicates that the first operation satisfies the first sub-condition but not the second sub-condition;
a adjusting unit configured to adjust a display effect of the first image, when the second determination result indicates that the first operation satisfies the third sub-condition;
a second acquiring unit configured to acquire the second target application corresponding to the first operation, based on the first operation satisfying the third sub-condition;
a third control unit configured to control the display unit to display the second image of the target application.

14. The electronic device of claim 13, wherein, the adjusting unit is configured to:
adjust the display effect of the first image so that the definition of the first display effect gradually decreases.
